(19) United States
(12) Patent Application Publication
(10) Pub. No.: US 2020/0347736 A1
(43) Pub. Date: Nov. 5, 2020

(54) GAS TURBINE ENGINE WITH FAN CASE HAVING INTEGRATED STATOR VANES

(71) Applicant: United Technologies Corporation, Farmington, CT (US)

(72) Inventors: Bradley L. Paquin, Cheshire, CT (US); George Alan Salisbury, East Hampton, CT (US); John D. Riehl, Hebron, CT (US); Kevin M. Bell, Higganum, CT (US)

(21) Appl. No.: 16/402,331

(22) Filed: May 3, 2019

(51) Int. Cl. F01D 9/04; B29C 70/08

(52) U.S. Cl. CPC F01D 9/041; B29C 70/08

(57) ABSTRACT

A gas turbine engine according to an exemplary aspect of the present disclosure includes, among other things, a fan case and a plurality of stator vanes integrally formed with the fan case. A method is also disclosed.

### BACKGROUND

A gas turbine engine typically includes a fan section, a compressor section, a combustor section, and a turbine section. Air entering the compressor section is compressed and delivered into the combustor section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

Gas turbine engines are known to include fan cases, which surround one or more arrays of fan blades and stator vanes. Fan cases are typically cylindrically shaped, and are known to be made of temperature resistant materials such as metals or composites.

### SUMMARY

A gas turbine engine according to an exemplary aspect of the present disclosure includes, among other things, a fan case and a plurality of stator vanes integrally formed with the fan case.

In a further non-limiting embodiment of the foregoing gas turbine engine, the plurality of stator vanes includes an array of stator vanes.

In a further non-limiting embodiment of any of the foregoing gas turbine engines, each stator vane in the array projects radially inward from the case.

In a further non-limiting embodiment of any of the foregoing gas turbine engines, the engine includes an inner platform, and each stator vane in the array projects radially inward from the case to the inner platform.

In a further non-limiting embodiment of any of the foregoing gas turbine engines, the inner platform is integrally formed with each of the stator vanes in the array.

In a further non-limiting embodiment of any of the foregoing gas turbine engines, the fan case and stator vanes are integrally molded of a composite material.

In a further non-limiting embodiment of any of the foregoing gas turbine engines, the fan case and stator vanes are formed using a resin transfer molding process.

In a further non-limiting embodiment of any of the foregoing gas turbine engines, the composite material is a polymer matrix composite material.

In a further non-limiting embodiment of any of the foregoing gas turbine engines, the polymer matrix composite material includes reinforcing fibers bound together by a polymer matrix.

In a further non-limiting embodiment of any of the foregoing gas turbine engines, the polymer matrix is provided by a polyimide material.

In a further non-limiting embodiment of any of the foregoing gas turbine engines, the polymer matrix is provided by a bismaleimide (BMI) material.

In a further non-limiting embodiment of any of the foregoing gas turbine engines, the reinforcing fibers include one of carbon fibers, aramid fibers, glass fibers, and ceramic fibers.

In a further non-limiting embodiment of any of the foregoing gas turbine engines, the plurality of stator vanes includes a first array of stator vanes and a second array of stator vanes axially spaced-apart from the first array of stator vanes.

In a further non-limiting embodiment of any of the foregoing gas turbine engines, the fan case includes a fore section integrally formed with the first array of stator vanes and an aft section integrally formed with the second array of stator vanes.

In a further non-limiting embodiment of any of the foregoing gas turbine engines, the fore section is made of a polymer matrix composite including reinforcing fibers held together by a matrix provided by a bismaleimide (BMI) material.

In a further non-limiting embodiment of any of the foregoing gas turbine engines, the fan case is configured to radially surround fan blades of the gas turbine engine.

A method according to an exemplary aspect of the present disclosure includes, among other things, inserting a reinforcement structure into a mold cavity, and injecting a polymer resin into the mold cavity to integrally form a fan case of a gas turbine engine with a plurality of stator vanes.

In a further non-limiting embodiment of the foregoing method, the polymer resin is one of polyimide and bismaleimide (BMI).

In a further non-limiting embodiment of any of the foregoing methods, the method includes allowing the polymer resin and reinforcement structure to cool such that the polymer resin and the reinforcement structure form a polymer matrix composite (PMC) material.

In a further non-limiting embodiment of any of the foregoing methods, the reinforcement structure includes one of carbon fibers, aramid fibers, glass fibers, and ceramic fibers.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 schematically illustrates a gas turbine engine.

FIG. 2 is a perspective view of an example engine component.

FIG. 3 is a front view of the example engine component.

FIG. 4 is close-up view of the example engine component, and in particular illustrates the intersection of the stator vanes and the fan case.

FIG. 5 schematically illustrates another example engine component.

### DETAILED DESCRIPTION

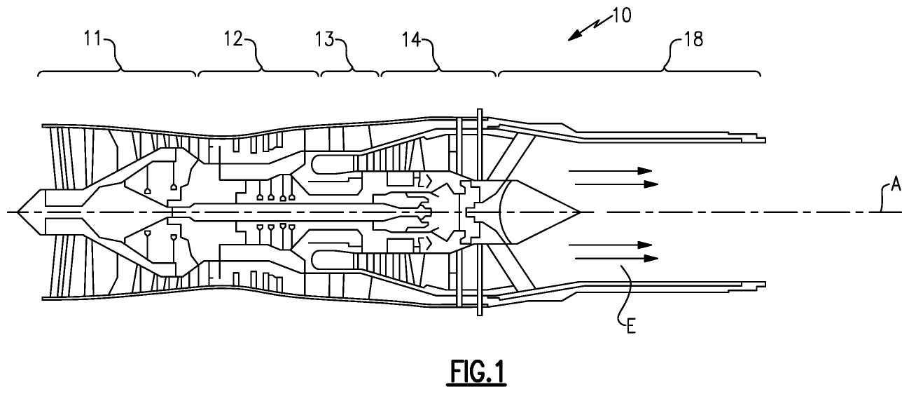

Referring to FIG. 1, a gas turbine engine 10 includes a fan section 11, a compressor section 12, a combustor section 13, and a turbine section 14. Air entering into the fan section 11 is initially compressed and fed to the compressor section 12. In the compressor section 12, the incoming air from the fan section 11 is further compressed and communicated to the combustor section 13. In the combustor section 13, the compressed air is mixed with gas and ignited to generate a hot exhaust stream E. The hot exhaust stream E is expanded through the turbine section 14 to drive the fan section 11 and the compressor section 12. The exhaust gasses E flow from the turbine section 14 through an exhaust liner assembly 18. Although a specific engine is depicted in FIG. 1, it should be understood that the concepts described may be applied to other types of turbine engines.

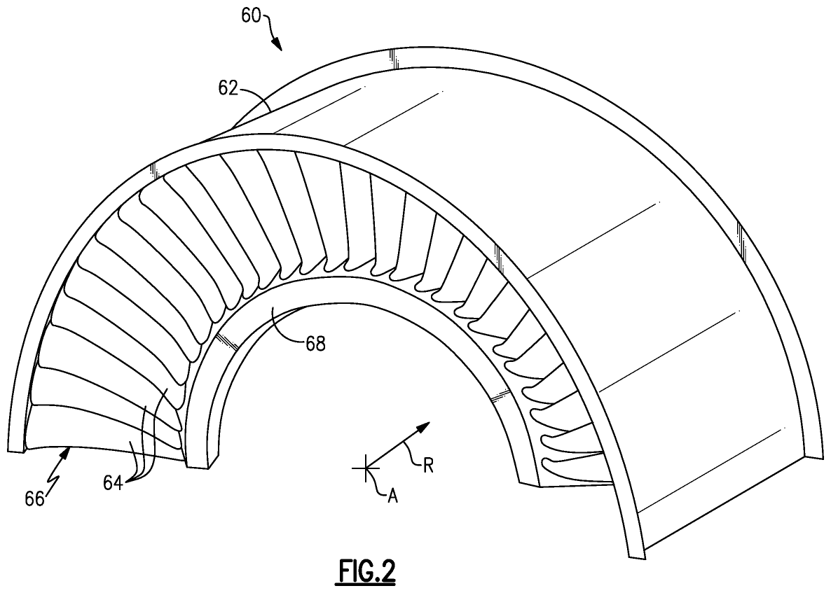

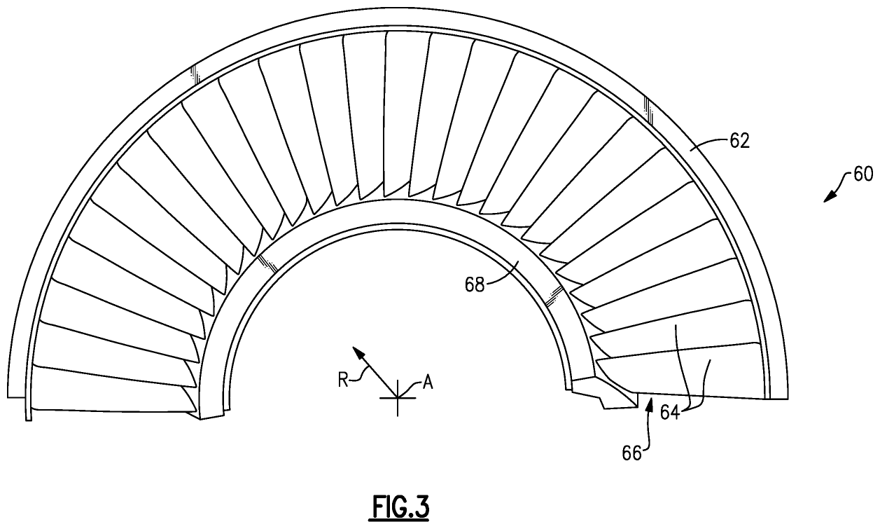

FIG. 2 illustrates an engine component 60 according to this disclosure from a perspective view, and FIG. 3 illustrates the engine component from a front view. With joint reference to FIGS. 2 and 3, the engine component 60 is a fan case 62 and provides a portion of the fan section 11 of the engine 10. In this disclosure, a plurality of stator vanes 64 are integrally formed with the fan case 62. In FIGS. 2 and 3, a first array 66 of stator vanes 64 is shown, and each of the stator vanes 64 is integrally formed with the fan case 62.

In FIGS. 2 and 3, the fan case 62 extends approximately 180° about the engine central longitudinal axis A. Specifically, the engine component 60 provides about half of the fan case 62 and first array 66, and the engine 10 includes a similar engine component which is arranged relative to the engine component 60 and completes the fan case 62 and the first array 66. In another embodiment the fan case 62 forms a complete circumferential hoop about the engine central longitudinal axis A and provides an entire fan case. In this other embodiment, the first array 66 of stator vanes 64 also extends about the entirety of the engine central longitudinal axis A.

While only one array of stator vanes is shown in FIGS. 2 and 3, there could be a second array of stator vanes integrally formed with the fan case 62 and axially spaced-apart from the first array 66. As is known, arrays of fan blades or other rotatable blades are configured to rotate about the engine central longitudinal axis A within the fan case 62 and adjacent the array(s) of stator vanes.

Again, in this disclosure, the fan case 62 is integrally formed with the stator vanes 64. Integrally formed means that the components are formed into one piece. In particular, the components that are referred to herein as integrally formed are formed together as part of the same manufacturing process and, when formed, provide a unitary structure without any joints or seams. Integrally forming the engine component 60 provides a number of benefits, including reducing weight of the engine 10, and reducing the number of component parts. Additional benefits will be appreciated from the below.

In a particular aspect of this disclosure, not only are the fan case 62 and stator vanes 64 integrally formed, but the engine component 60 also includes an inner platform 68 which is also integrally formed with each of the stator vanes 64. In particular, each stator vane 64 projects radially inward, relative to the radial direction R, which is normal to the engine central longitudinal axis A and labeled in the figures for reference, from the fan case 62 to the inner platform 68. The platform 68 is configured to connect to a structure of the engine 10, as is known in the art.

In this disclosure, the engine component 60 (i.e., the fan case 62, stator vanes 64, and inner platform 68) is integrally formed of a composite material. In a particular example, the engine component 60 is integrally formed of a polymer matrix composite (PMC) material including reinforcing fibers bound together by a polymer matrix. A polymer matrix composite (PMC) is a composite material composed of a variety of short or continuous fibers bound together by an organic polymer matrix. PMCs are designed to transfer loads between fibers through the matrix. PMCs are lightweight, exhibit high stiffness, and exhibit high strength along the direction of the reinforcing fibers. Other advantages are good abrasion resistance and good corrosion resistance.

The PMC material provides weight and cost benefits, and the fan case 62 may also exhibit enhanced containment capabilities relative to prior designs, in particular in the event of a blade out condition wherein the fan case 62 is relied upon to prevent a blade or fragments of a blade from being expelled outside the engine 10.

Example PMC materials which may be used to form the engine component 60 will now be described. In one example, the engine component 60 may be formed of a reinforcing structure bound together by polyimide or bismaleimide (BMI), both of which are polymer materials with high temperature resistance capabilities and which may provide enhanced containment capabilities. The reinforcing structure can be any known type of fiber material, including carbon fibers, aramid fibers, ceramic fibers, and glass fibers, as examples.

Polyimides are polymers of imide monomers. Polyimides exhibit high temperature resistance and also exhibit high strength and rigidity at elevated temperatures. One known type of polyimide is AFR-PE-4 made commercially available by Renegade Materials. BMIs are high performance thermosetting addition-type polyimides. Their characteristics are similar to those of polyimides, which exhibit high strength and high temperature resistance. One known BMI is CYCOM 5250-4 manufactured by Solvay.

The engine component 60 is manufactured by a resin transfer molding process in one example. In that example, the engine component 60 is formed first by inserting the reinforcing structure (i.e., the carbon, aramid, ceramic, or glass fibers) into a mold cavity, and then injecting polymer resin into the mold cavity. Again, the polymer resin is one of polyimide and bismaleimide (BMI). Following injection, the part is allowed to cool, and then it is removed from the mold.

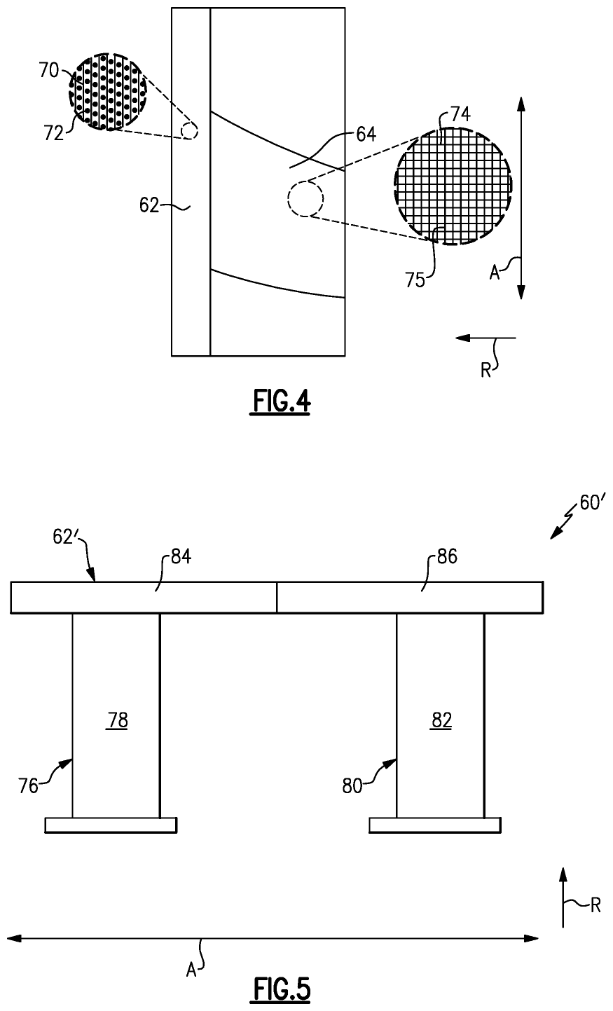

In one example, the reinforcement structure is arranged differently in the fan case 62 and the stator vanes 64. In particular, relative to FIG. 4, the fan case 62 includes a plurality of first fibers 70 extending in a direction parallel to the engine central longitudinal axis A and a plurality of second fibers 72 interwoven with the first fibers 70 and extending circumferentially about the engine central longitudinal axis A, which is represented as in-and-out of the page relative to FIG. 4. This arrangement of fibers, which may be braided and/or 3D-woven, relative to the fan case 62 provides enhanced containment capabilities. To this end, the fan case fiber arrangement shown in FIG. 4 may be limited to areas in the engine 10 where containment is needed. Relative to the stator vanes 64, the reinforcement structure includes a plurality of first fibers 74 extending in a direction parallel to radial direction R and a plurality of second fibers 75 interwoven with the first fibers 74 and extending in a direction parallel to the engine central longitudinal axis A. This fiber arrangement relative to the stator vanes 64 provides for optimum vane performance.

FIG. 5 schematically illustrates another engine component 60′ according to this disclosure. In FIG. 5, the fan case 62′ includes a first array 76 of stator vanes 78 and a second array 80 of stator vanes 82 axially spaced-apart from the first array 76 along the engine central longitudinal axis. In this example, the fan case 62′ includes two sections, namely a fore section 84 and an aft section 86. The fore section 84 is integrally formed with the first array 76 of stator vanes 78, and the aft section 86 is integrally formed with the second array 80 of stator vanes 82. The fore section 84 is made of a polymer matrix composite including reinforcing fibers held together by a matrix provided by a bismaleimide (BMI) material, in one example. In this example, the aft section 86 is made of another material, which may be of higher temperature capability and greater cost, as examples, than the material forming the fore section 84. The arrangement of FIG. 5 provides the fore section 84 with enhanced containment capabilities, high temperature resistance, and high strength, while saving on cost. While the fan case 62′ in FIG. 5 is not a unitary, seamless structure, it still reduces the number of component parts relative to traditional designs, and provides enhanced material properties in the fore section 84, which is the section most likely to need such enhanced properties in some scenarios.

It should be understood that terms such as “fore,” “aft,” “axial,” “radial,” and “circumferential” are used above with reference to the normal operational attitude of the engine 10. Further, these terms have been used herein for purposes of explanation, and should not be considered otherwise limiting. Terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A gas turbine engine, comprising:
a fan case; and
a plurality of stator vanes integrally formed with the fan case.

2. The gas turbine engine as recited in claim 1, wherein the plurality of stator vanes includes an array of stator vanes.

3. The gas turbine engine as recited in claim 2, wherein each stator vane in the array projects radially inward from the case.

4. The gas turbine engine as recited in claim 3, further comprising an inner platform, wherein each stator vane in the array projects radially inward from the case to the inner platform.

5. The gas turbine engine as recited in claim 4, wherein the inner platform is integrally formed with each of the stator vanes in the array.

6. The gas turbine engine as recited in claim 1, wherein the fan case and stator vanes are integrally molded of a composite material.

7. The gas turbine engine as recited in claim 6, wherein the fan case and stator vanes are formed using a resin transfer molding process.

8. The gas turbine engine as recited in claim 6, wherein the composite material is a polymer matrix composite material.

9. The gas turbine engine as recited in claim 8, wherein the polymer matrix composite material includes reinforcing fibers bound together by a polymer matrix.

10. The gas turbine engine as recited in claim 9, wherein the polymer matrix is provided by a polyimide material.

11. The gas turbine engine as recited in claim 9, wherein the polymer matrix is provided by a bismaleimide (BMI) material.

12. The gas turbine engine as recited in claim 9, wherein the reinforcing fibers include one of carbon fibers, aramid fibers, glass fibers, and ceramic fibers.

13. The gas turbine engine as recited in claim 1, wherein the plurality of stator vanes includes a first array of stator vanes and a second array of stator vanes axially spaced-apart from the first array of stator vanes.

14. The gas turbine engine as recited in claim 13, wherein the fan case includes a fore section integrally formed with the first array of stator vanes and an aft section integrally formed with the second array of stator vanes.

15. The gas turbine engine as recited in claim 14, wherein the fore section is made of a polymer matrix composite including reinforcing fibers held together by a matrix provided by a bismaleimide (BMI) material.

16. The gas turbine engine as recited in claim 1, wherein the fan case is configured to radially surround fan blades of the gas turbine engine.

17. A method, comprising:
inserting a reinforcement structure into a mold cavity; and
injecting a polymer resin into the mold cavity to integrally form a fan case of a gas turbine engine with a plurality of stator vanes.

18. The method as recited in claim 17, wherein the polymer resin is one of polyimide and bismaleimide (BMI).

19. The method as recited in claim 17, further comprising:
allowing the polymer resin and reinforcement structure to cool such that the polymer resin and the reinforcement structure form a polymer matrix composite (PMC) material.

20. The method as recited in claim 19, wherein the reinforcement structure includes one of carbon fibers, aramid fibers, glass fibers, and ceramic fibers.
